(19) United States
(12) Patent Application Publication
(10) Pub. No.: US 2024/0298312 A1
(43) Pub. Date: Sep. 5, 2024

(54) RESTRICTED TARGET-WAIT TIME COOPERATION FOR INTER-BASIC-SERVICE-SETS

(71) Applicants: SONY GROUP CORPORATION, Tokyo (JP); SONY CORPORATION OF AMERICA, New York, NY (US)

(72) Inventor: Qing Xia, San Jose, CA (US)

(73) Assignees: SONY GROUP CORPORATION, Tokyo (JP); SONY CORPORATION OF AMERICA, New York, NY (US)

(21) Appl. No.: 18/435,638

(22) Filed: Feb. 7, 2024

Related U.S. Application Data
(60) Provisional application No. 63/488,256, filed on Mar. 3, 2023.

(51) Int. Cl. H04W 72/12; H04W 72/541; H04W 72/566; H04W 74/0816; H04W 84/12

(52) U.S. Cl. CPC H04W 72/12; H04W 72/541; H04W 72/569; H04W 74/0816; H04W 84/12

(57) ABSTRACT

Wireless protocol enhancements are provided for allowing inter-BSS stations/APs to support, negotiate and participate in cooperative R-TWT SPs that are overlapped in time and are scheduled on different links or different channels to avoid the inter-BSS interference of prioritized traffic that has been scheduled to transmitted during the corresponding R-TWT SPs. The protocol makes use of new subfield elements toward informing, negotiating and supporting the cooperative R-TWT SPs.

### CROSS-REFERENCE TO RELATED APPLICATIONS

This application claims priority to, and the benefit of, U.S. provisional patent application Ser. No. 63/488,256 filed on Mar. 3, 2023, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to Restricted Target Wake Time (R-TWT) operations under IEEE802.11, and more particularly to overcoming communication blockage issues with Overlapping Basic Service Sets (BSSs) during R-TWT Service Periods (SPs).

### 2. Background Discussion

The use of Restricted Target Wake Time (R-TWT) was introduced in IEEE802.11be. Under certain circumstances interference can arise when R-TWT operations performed on different Basic Service Sets (BSSs) which overlap one another (OBSSs).

Accordingly, a need exists for improved R-TWT control which overcomes blocking/interference issues. The present disclosure fulfills that need and provides additional benefits over existing systems.

### BRIEF SUMMARY

The protocol of the present disclosure allows inter-Basic Service Set (inter-BSS) devices to negotiate and participate in cooperative Restricted-Target Wake Time (R-TWT) Service Periods (SPs) that are overlapped in time, and which are scheduled on different links or different channels, thereby avoiding inter-BSS interference of the prioritized traffic that has been scheduled for transmission during the corresponding R-TWT SPs.

The present disclosure describes inter-BSS signaling mechanisms which indicate that support is being provided by the protocol for inter-BSS cooperative R-TWTs. The inter-BSS APs obtain information from the cooperative BSS before the cooperative R-TWT negotiation process. Inter-BSS APs in this protocol are configured to allow performing cooperation with one another while negotiating R-TWT membership on channel level. Inter-BSS APs are also configured to allow performing cooperation with each other to negotiate R-TWT membership on link level, insofar as it does not violate the TID-to-link mapping.

In the disclosed protocol, the size of the Restricted TWT schedule Information subfield of the Broadcast TWT Info subfield in a TWT element can be increased, for example by 1 bit (originally 2 bit) with a newly defined field value e.g., ‘4’ indicating the advertised R-TWT schedule for which the R-TWT scheduling AP is likely to cooperate with another R-TWT scheduling AP from OBSS.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a block diagram of communication station (STA) hardware, according to at least one embodiment of the present disclosure.

FIG. 2 is a block diagram of Multi-Link Device (MLD) hardware according to at least one embodiment of the present disclosure.

FIG. 3 is a network topology diagram to aid in understanding the example scenarios as described according to at least one embodiment of the present disclosure.

FIG. 4-1 and FIG. 4-2 are a communication diagram as Example 1 of negotiating R-TWT membership on a link level, as performed according to at least one embodiment of the present disclosure.

FIG. 5-1 and FIG. 5-2 is a communication diagram, as Example 2, of negotiating R-TWT membership on a channel level without a trigger-enabled R-TWT SP, as performed according to at least one embodiment of the present disclosure.

FIG. 6-1 and FIG. 6-2 is a communication diagram, as Example 3 of negotiating R-TWT membership on a channel level with a trigger-enabled R-TWT SP, as performed according to at least one embodiment of the present disclosure.

FIG. 7-1 through FIG. 7-3 is a flow diagram of R-TWT negotiations performed from the AP side, according to at least one embodiment of the present disclosure.

FIG. 8-1 and FIG. 8-2 are a flow diagram of R-TWT negotiations performed from the non-AP side according to at least one embodiment of the present disclosure.

FIG. 9 is a data field diagram of a LinkID-To-Channel-BSSID mapping element format utilized according to at least one embodiment of the present disclosure.

FIG. 10 is a data field diagram of subfields within the LinkID-To-channel-BSSID mapping control field which was shown in FIG. 9, as utilized according to at least one embodiment of the present disclosure.

FIG. 11 is a data field diagram of the subfields within the LinkID n Mapping field, for which LinkID 1 Mapping field through LinkID 15 Mapping fields were depicted in FIG. 9, as utilized according to at least one embodiment of the present disclosure.

FIG. 12 is a data field diagram of a Broadcast TWT Parameter Set field format for use in a channel or link level cooperative R-TWT negotiation, as utilized according to at least one embodiment of the present disclosure.

FIG. 13 is a data field diagram of subfields of the Broadcast TWT Information field that was shown in FIG. 12, as utilized according to at least one embodiment of the present disclosure.

### DETAILED DESCRIPTION

### 1. Introduction of Restricted Target Wake Time (R-TWT)

The following description considers the case of an R-TWT scheduling Access Point (AP), which is an Extra High Throughput (EHT) AP, having subfield ‘dot11TWTOptionActivated’ equal to true that sets the Restricted TWT Support subfield in the transmitted EHT Capabilities element to a value of ‘1’. An R-TWT scheduled station (STA) that is a non-AP EHT STA sets the Restricted TWT Support subfield in the transmitted EHT Capabilities element to a value of ‘1’ and sends to, or receives from, a broadcast TWT element carrying one or more R-TWT Parameter Set field(s) from an R-TWT scheduling AP.

A non-AP EHT STA establishes membership for one or more R-TWT schedules with its associated EHT AP. An EHT AP that has dot11RestrictedTWTOptionImplemented set to true may announce one or more R-TWT Service Periods (SPs).

The R-TWT SP is setup (established) between the R-TWT scheduling AP and the R-TWT member non-AP STA(s) to serve a certain Traffic Identifier (TID), or multiple TIDs, that carry latency sensitive traffic in Uplink (UL) and/or Downlink (DL) directions for the R-TWT member. Thus, when a TID is not mapped to, or is no longer mapped to, a link on which the R-TWT membership is set up (established), then the corresponding R-TWT membership is considered as having been torn-down.

The R-TWT scheduling AP announces the R-TWT scheduling information by transmitting Management frames carrying the TWT element, which may indicate the Target Wake Time corresponds to a Timing Synchronization Function (TSF) time at which the scheduled STA requests to wake for the corresponding R-TWT SP(s). The value of the TSF corresponds to the first R-TWT SP start time of the corresponding R-TWT agreement. The R-TWT scheduling AP determines the start time of the next R-TWT SPs (after the first R-TWT SP) in a periodic R-TWT schedule based on the start time of the first R-TWT SP and the TWT wake interval. A TSF is used to maintain synchronization for the timers of all STAs in the same BSS. The AP is the timing master of the TSF and periodically transmits Beacon frames containing the AP's TSF timer as a timestamp to synchronize the TSF timers of other STAs in its BSS.

### 2. Problem STATEMENT

The potential issue arises from the existence of an OBSS, when the OBSS has a scheduled R-TWT SP which overlaps with the R-TWT SP scheduled in the time domain of the BSS under consideration. The scheduled transmission to, or reception from, R-TWT member STAs of the overlapped inter-BSS R-TWT SPs are also utilizing the same prioritized channel access, and thus, interference (blocking) of each other can arise when accessing the channel during the overlapped inter-BSS R-TWT SPs.

### 3. Contribution of the Invention

Toward solving the blockage issue, a design is described for providing cooperative R-TWT SP negotiation in the frequency domain when the inter-BSS R-TWT SPs are overlapped in time.

The cooperation commences before the R-TWT negotiation stage, by enabling the cooperative BSSs to indicate their capability of inter-BSS cooperation during overlapped R-TWT SPs. This information enables the cooperative BSSs to understand each other in regard to TSF and Target Beacon Transmission Time (TBTT) offset, or mismatch, of cooperative BSSs, the cooperative BSS(s) channel information and the corresponding link ID, and any other desired information as depending on the application.

During the R-TWT negotiation stage, the cooperative APs negotiate the overlapped inter-BSS R-TWT SPs by scheduling them to different links or to different channels in the same link to avoid the interference.

### 4. Hardware Embodiments

### 4.1. Communication Station (STA and MLD) Hardware

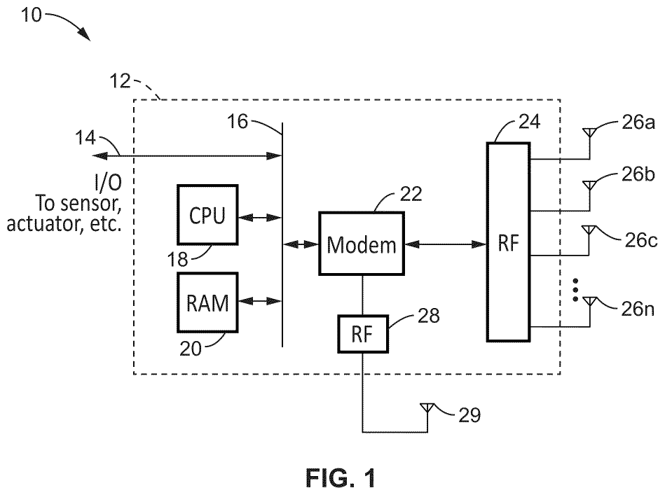

FIG. 1 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows for performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an access point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

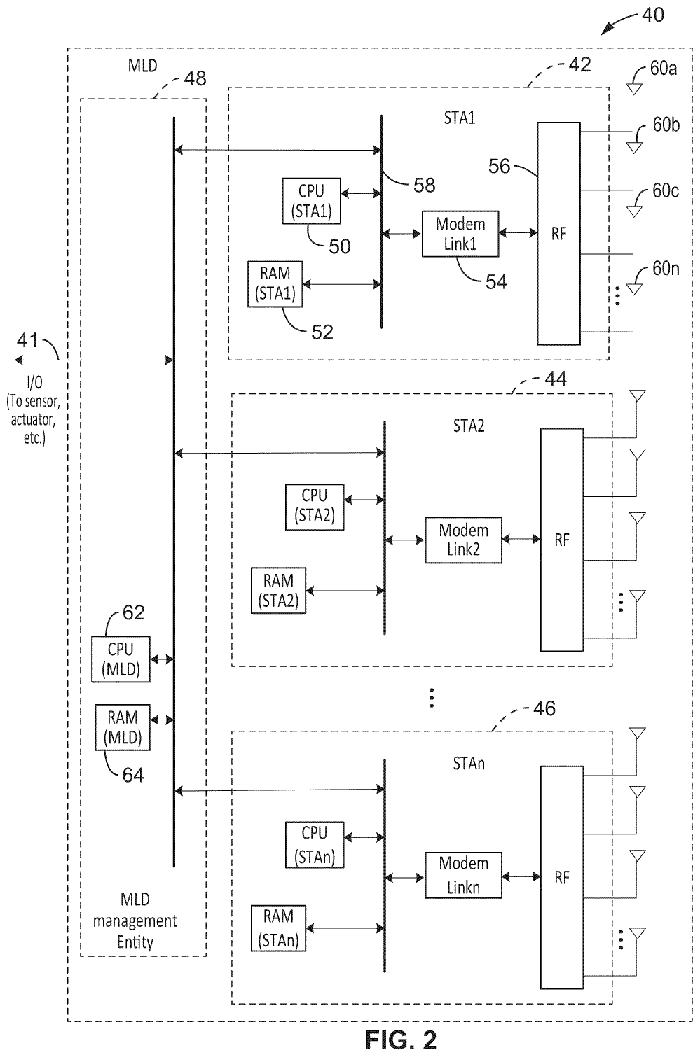

FIG. 2 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHz. Among multiple radios, basic link sets are the link pairs that satisfy simultaneous transmission and reception (STR) mode, e.g., basic link set (2.4 GHz and 5 GHz), basic link set (2.4 GHz and 6 GHz).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA1 42, STA2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

### 5. Example Network Topology

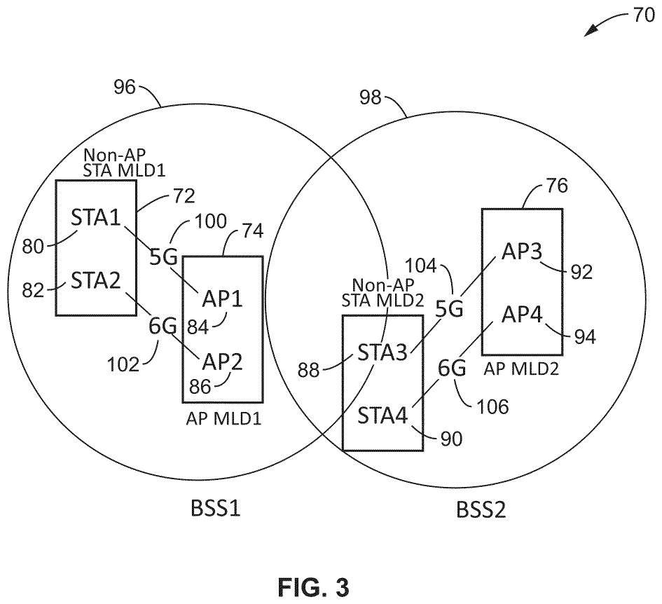

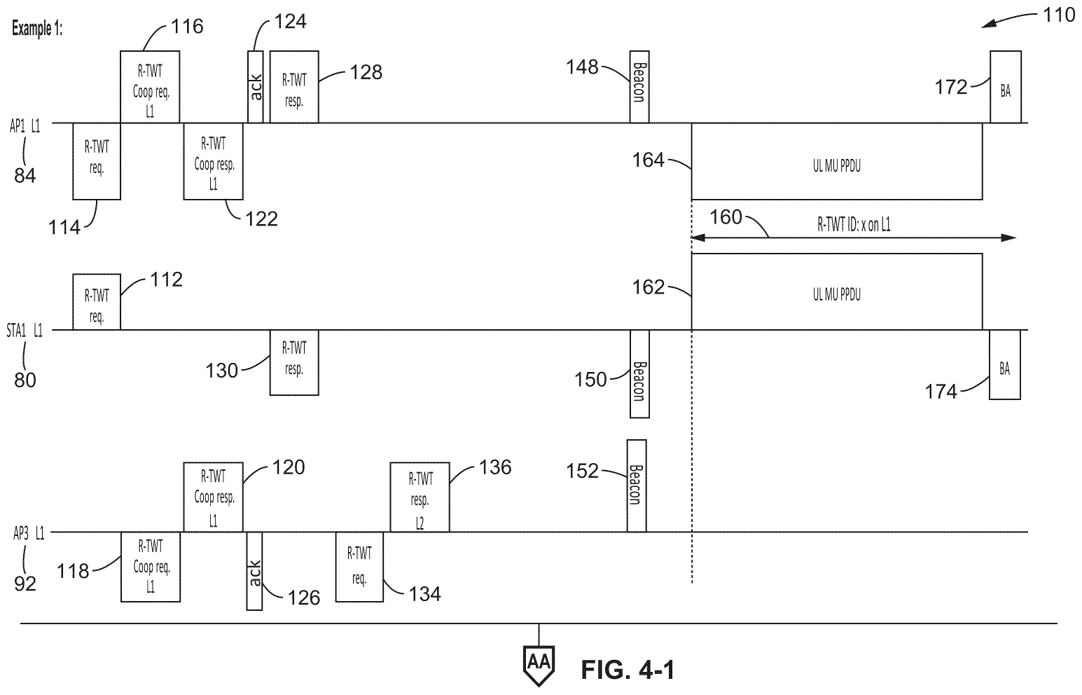

FIG. 3 illustrates an example network topology 70 utilized as an aid in describing operational examples. It should be noted that the present disclosure is not limited in terms of being restricted to any specific topology. In the example shown BSS1 96 and BSS2 98 are neighboring BSSs. In BSS1, non-AP STA MLD1 72 has two affiliated non-AP STAs, STA1 80 and STA2 82, which associate with AP1 84 and AP2 86 on 5 GHz link (L1) 100 and 6 GHz link (L2) 102, respectively. AP1 and AP2 are affiliated with AP MLD1. In BSS2, non-AP STA MLD2 88 has two affiliated non-AP STAs, as STA3 88 and STA4 90, which associate with AP3 92 and AP4 94, over 5 GHz link (L1) 104 and 6 GHz link (L2) 106, respectively. AP3 and AP4 are affiliated with AP MLD2.

The present disclosure refers to the BSS, or the AP of the BSS that is requesting the R-TWT cooperation with the neighbor BSS, or the AP of the neighbor BSS as the R-TWT cooperation requesting BSS or R-TWT cooperation requesting AP, respectively. The present disclosure refers to the corresponding neighbor BSS, or the AP of the neighbor BSS, as an R-TWT cooperation response BSS or an R-TWT cooperation response AP, respectively.

### 6. Cooperative R-TWT Negotiation

Toward achieving this R-TWT cooperation, a capability flag is described herein which indicates enabling of a cooperative R-TWT. If the cooperative R-TWT capability flag is set to true, then the AP should be able to cooperate with the neighboring AP, which also sets this cooperative R-TWT capability flag to true during R-TWT negotiation. The following information is needed from the cooperative BSS before the cooperative R-TWT negotiation.
(a) Implementations are needed to compensate for the Timing Synchronization Function (TSF) and Target Beacon Transmission Time (TBTT) offset/mismatch of cooperative BSSs. The AP can obtain the neighbor report information of OBSS(s) through measurement reports received from the STAs within the BSS, or obtain the information through a management interface, or information from the Distribution System (DS). The neighbor report contains information including the BSSID, the primary channel, TSF Offset, Beacon interval, and other information as required for a specific situation or application of the reported neighbor BSS.
(b) Information will be required to understand channel information of neighbor BSS(s). In at least one embodiment, the AP maintains a list of channel information that corresponds to its neighbor APs. The channel information may be obtained from the neighbor report received from the neighbor AP(s). In at least one embodiment, the list of channel information can be contained in the AP Channel Report element as carried in the Beacon frame.

The channel information corresponds to an operating class, which indicates the following: (i) the frequencies corresponding to channel numbers; (ii) the channel center frequencies that may be used; (iii) the maximum channel width that may be used; and (iv) other information as may be required for a specific implementation(s).
(c) In some instances, the AP may benefit from understanding (obtaining and recognizing) the link IDs of the neighbor cooperative BSS. Since a link ID is a numeric value that corresponds to a tuple consisting of operating class, operating channel and BSSID of the AP on that link; the AP requesting the neighboring BSS's link IDs needs to understand the explicit link ID value corresponding to which tuple of operating class, operating channel and BSSID of AP on that link. In addition, the AP may benefit from understanding (obtaining and recognizing) the TID-to-Link (T2L) mapping of the neighboring cooperative BSS. Frame exchanges are utilized to exchange this information between BSSs that set the cooperative R-TWT capability flag to true before, or during, the cooperative inter-BSS R-TWT negotiation.

The frame to be exchanged shall carry information as described below. (a) TID-To-Link Mapping element based on the current IEEE 802.11 be specification: Draft P802.11be_D5.0, “Part 11: Wireless LAN Medium Access Control (MAC) and Physical Layer (PHY) Specifications-Amendment 8: Enhancements for extremely high throughput (EHT)”, November 2023. (b) A LinkID-To-Channel-BSSID Mapping element, which is designed in this disclosure to indicate the mapping of a linkID to the tuple of operating class, operating channel and BSSID of the AP on that link. (c) A Cooperative R-TWT capability flag, which is designed in this disclosure, that when set to true indicates that the STA which transmitted this frame supports cooperative R-TWT scheduling with the R-TWT cooperation response BSS in frequency domain when overlapped R-TWT SPs occur in the time domain.

### 6.1. Negotiate Cooperative R-TWT in the Frequency Domain

To achieve frequency division, the cooperative TWT negotiation can be performed either on link level or on channel level. Example 1 (below) is used to illustrate this process of link level negotiation.

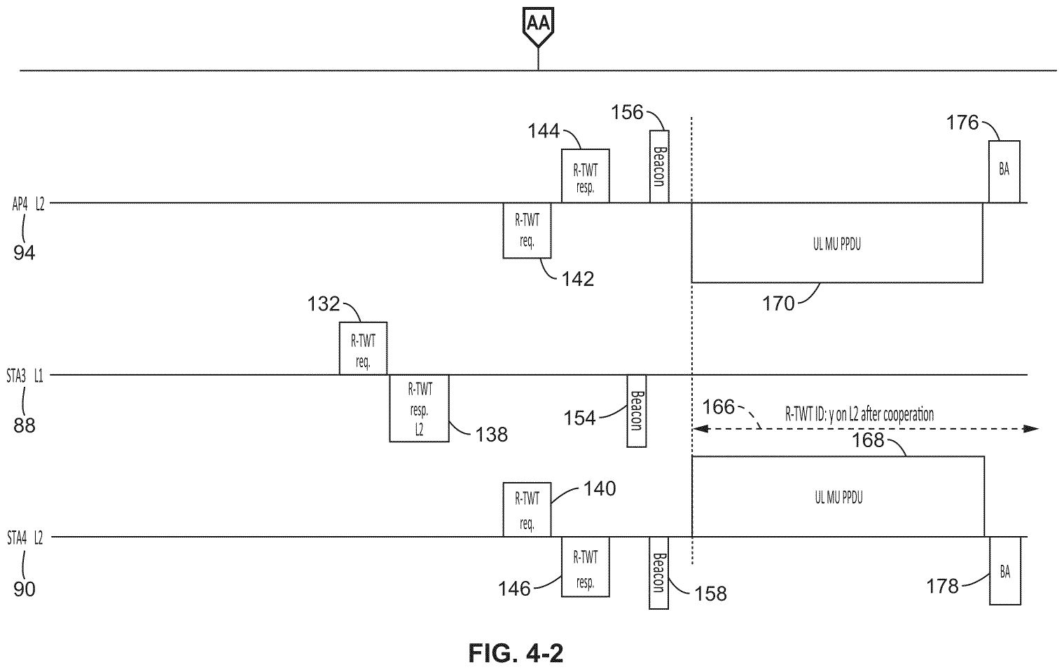

FIG. 4-1 and FIG. 4-2 illustrates a communication diagram 110 as Example 1, depicting negotiating R-TWT membership on a link level. The figure depicts interactions between AP1 84 on L1, STA1 80 on L1, AP3 92 on L1, and AP4 94 on L2.

STA1 transmits a R-TWT request frame 112 to its associated AP1 on link 1 (L1) that it has requested or suggested to operate on L1 during the negotiated R-TWT SP (ID: x).

AP1 receives 114 the R-TWT request frame from STA1 and transmits R-TWT cooperation request frame 116 to AP3 of the R-TWT cooperation response BSS on link 1 (L1). In the R-TWT cooperation request frame, the TWT element with R-TWT channel field indicates the current negotiation R-TWT information with the suggested/requested link (L1) of the corresponding R-TWT SP in the R-TWT cooperation request BSS. The suggested/requested link (L1) is decided per the R-TWT requesting STA's suggestion/request or per the R-TWT scheduling AP's selection.

AP3 receives 118 the R-TWT cooperation request frame 116 from AP1 on link 1 (L1) and should check the R-TWT negotiation information of the R-TWT cooperation request BSS and decide if the negotiated R-TWT SP (ID: x) will overlap with any of the scheduled/negotiated R-TWT SP(s) from its own BSS on L1. AP3 responds with a R-TWT cooperation response frame 120 to AP1 with indicating its acceptance of allocating the requested link L1 to the R-TWT cooperation request BSS during the corresponding R-TWT SP (ID: x).

AP1 receives 122 the R-TWT cooperation response frame from AP3 and should respond with an Ack frame 124 to indicate successful reception, and this is shown received 126 by AP3. Then, AP1 sends the R-TWT response frame 128 to STA1 indicating the acceptance of the R-TWT schedule of R-TWT SP (ID: x), and this is received 130 by STA1.

STA3 transmits a R-TWT request frame 132 to its associated AP3 on link 1 (L1) that it requested/suggested to operate on L1 during the negotiated R-TWT SP (ID: y).

AP3 receives 134 the R-TWT request frame 132 from STA3 that requests/suggests operating on L1 during R-TWT SP (ID: y), which will overlap with R-TWT SP (ID: x) on L1 that was scheduled for the R-TWT cooperation request BSS. AP3 responds by sending a R-TWT response frame 136 to STA3 indicating the request/suggest operating on L1 is not accepted and a different link (L2) is requested/suggested for the negotiated R-TWT SP (ID: y).

STA3 receives 138 the R-TWT response frame 136 from AP3 then it allows STA4, which affiliates with the same non-AP MLD2 as STA3, to transmit a R-TWT request frame 140 on link 2 (L2) indicating it requests/suggests operating on L2 during the negotiated R-TWT SP (ID: y).

AP4 receives 142 the R-TWT request frame 140 from STA4 and then responds by sending a R-TWT response frame 144 indicating that it accepts the R-TWT schedule as suggested/requested in the received R-TWT requested frame. STA4 receives 146 the R-TWT response frame 144 from AP4.

AP1 transmits Beacon frame 148 over link 1, and STA1 receives 150 Beacon frame 148 from AP1 over link 1. AP3 transmits 152 Beacon frame over link 1, and STA3 receives 154 Beacon frame 152 from AP3 over link 1. AP4 transmits 156 Beacon frame over link 2, and STA4 receives 158 Beacon frame 156 from AP4 over link 2. It should be appreciated, as specified in 802.11REVme, that a beacon frame can be used to carry a broadcast TWT element that indicates broadcast TWT SP schedule, such as the target wake time, TWT wake interval, and so forth.

When R-TWT SP (ID: x) 160 commences, STA1 transmits UL MU PPDU 162, which is received 164 by AP1, which sends Block Ack (BA) 172 which is received 174 by STA1 on L1.

When R-TWT SP (ID: y) 166 commences, STA4 transmits a UL MU PPDU 168, which is received 170 by AP4 which sends a Block Ack (BA) 176 which is received by STA4 on L2.

### 6.2. Negotiating R-TWT Membership on the Channel Level

When users from inter BSSs map TID(s) only to one link which corresponding to the same operating class and operating channel, then we cannot negotiate R-TWT membership on link level. A finer frequency allocation is needed. That means should negotiate R-TWT membership on channel level. Examples 2 and 3 are used to illustrate how it works on channel level negotiation.

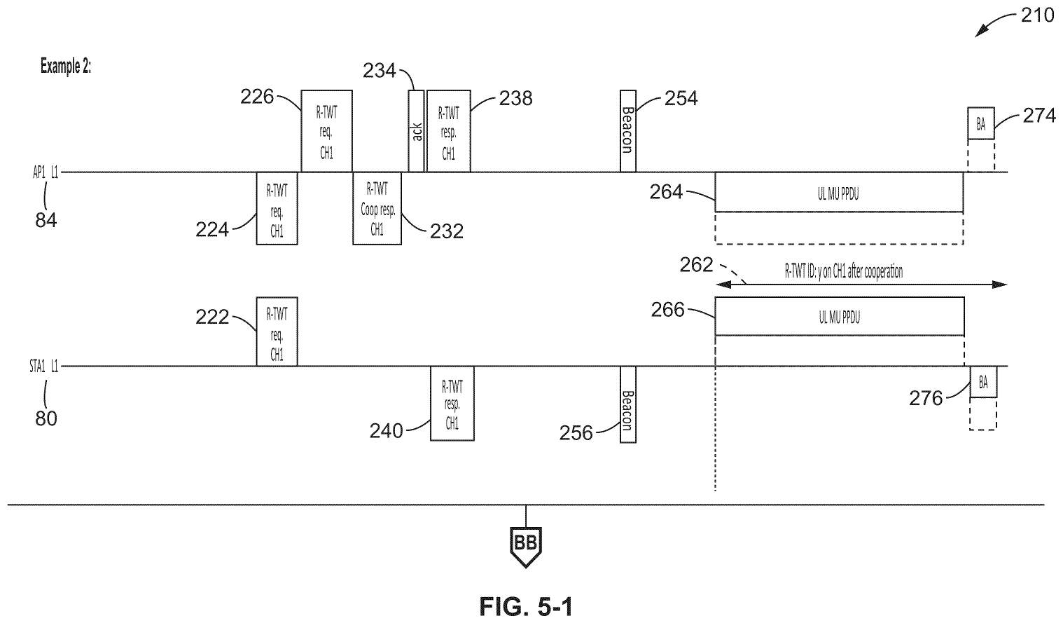

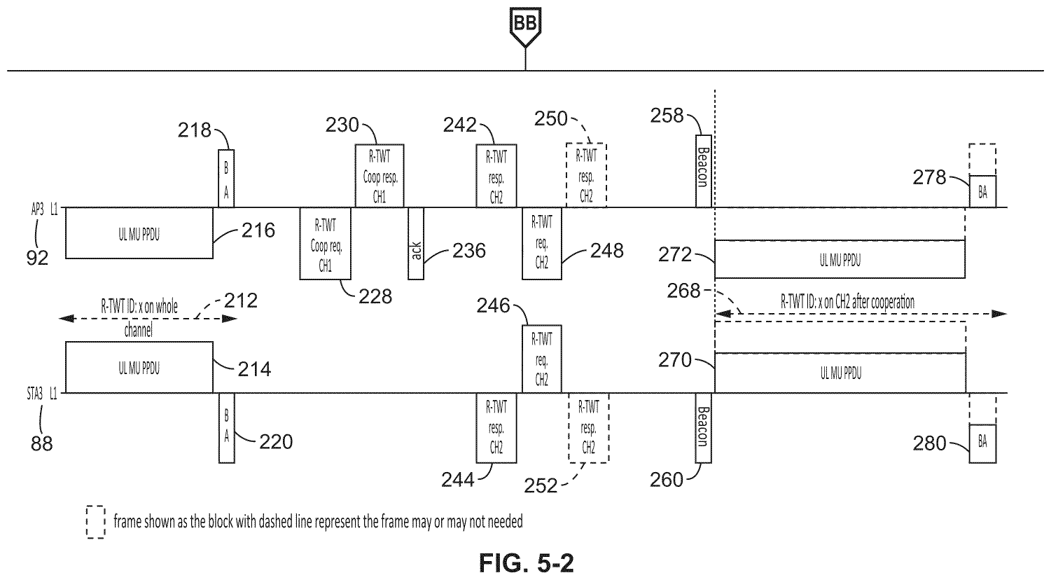

FIG. 5-1 and FIG. 5-2 illustrates a communication diagram 210 as Example 2, depicting negotiating R-TWT membership on a channel level without a trigger-enabled R-TWT SP. The figure depicts interactions between AP1 84 on L1, STA1 80 on L1, AP3 92 on L1, and STA3 88 on L1. STA3 is a R-TWT member STA of R-TWT SP (ID: x), which is not a trigger enabled R-TWT SP on link 1 (L1).

The initial negotiation process of R-TWT SP (ID: x) is not shown in the figure. When R-TWT SP (ID x) 212 starts, STA3 transmits a UL MU PPDU 214 to be received 216 by its associated AP3, which sends a Block Ack (BA) frame 218 on whole channel, which is shown received 220 by STA3.

STA1 transmit a R-TWT request frame 222 to its associated AP1 on link 1 (L1), with or without, indicating channel information (CH1) that it requested/suggested to operate on during the negotiated R-TWT SP (ID: y) if the R-TWT SP will be overlapped with any inter-BSS R-TWT SP.

AP1 receives 224 the R-TWT request frame 222 from STA1 and transmits a R-TWT cooperation request frame 226 to be received 228 by AP3 of the R-TWT cooperation response BSS on link 1 (L1). In the R-TWT cooperation request frame, the TWT element with R-TWT channel field indicates the current negation R-TWT information with the suggested/requested channel (CH1) of the corresponding R-TWT SP in the R-TWT cooperation request BSS. The suggested/requested channel (CH1) is decided per the R-TWT requesting STA's suggestion/request or per the R-TWT scheduling AP's selection.

AP3 receives the R-TWT cooperation request frame 228 from AP1 on link 1 (L1) and should check the R-TWT negotiation information of the R-TWT cooperation request BSS and decide the negotiated R-TWT SP (ID: y) will overlap with the schedule R-TWT SP (ID: x) from its own BSS. AP3 should respond a R-TWT cooperation response frame 230 with indications of its acceptance of allocating the requested channel CH1 to the R-TWT cooperation request BSS during the corresponding R-TWT SP (ID: y).

AP1 receives 232 the R-TWT cooperation response frame 230 from AP3 and should respond with an Ack frame 234 to indicate successful reception, and this is shown being received 236 by AP3. Then, AP1 sends a R-TWT response frame 238, indicating acceptance of allocation for channel (CH1) to STA1 during R-TWT SP (ID: y), and this is shown being received 240 by STA1.

AP3 should transmit an unsolicited R-TWT response frame 242 to the R-TWT member STAs of R-TWT SP (ID: x) which includes STA3, shown receiving 244 this response frame. In the R-TWT response frame, AP3 should indicate the updated negation R-TWT information with the suggested/requested channel (CH2) of the corresponding R-TWT SP (ID: x).

In this example, STA3 upon receiving the unsolicited R-TWT response frame from AP3, agrees with the updated channel allocation. STA3 sends a new R-TWT request frame 246 with suggested/requested updated channel (CH2) for the corresponding R-TWT SP (ID: x) which is received 248 by AP3. AP3 then optionally send a R-TWT response frame 250 indicating the acceptance of the suggest/request updates of channel (CH2), and this is shown being received 252 by STA3.

AP1 transmits Beacon frame 254 over link 1, and STA1 receives 256 Beacon frame 254 from AP1 over link 1. AP3 transmits Beacon frame 258 over link 1, and STA3 receives 260 Beacon frame 258 from AP3 over link 1

The negotiated R-TWT SP (ID: y) between STA1 and AP1 is not a trigger enabled R-TWT SP. When R-TWT SP (ID: y) 262 commences, STA1 uses negotiated channel (CH1) to transmit UL MU PPDU 266, which is shown received 264 by AP1 which transmits a Block Ack (BA) frame 274, which is then shown being received 276 by AP3.

When R-TWT SP (ID: x) 268 commences, STA3 uses negotiated channel (CH2) to transmit UL MU PPDU 270, which is shown being received 272 by AP3 which sends a Block Ack (BA) frame 278, that is received 280 by STA3.

6.3. Negotiating R-TWT Membership on the Channel Level w/Trigger

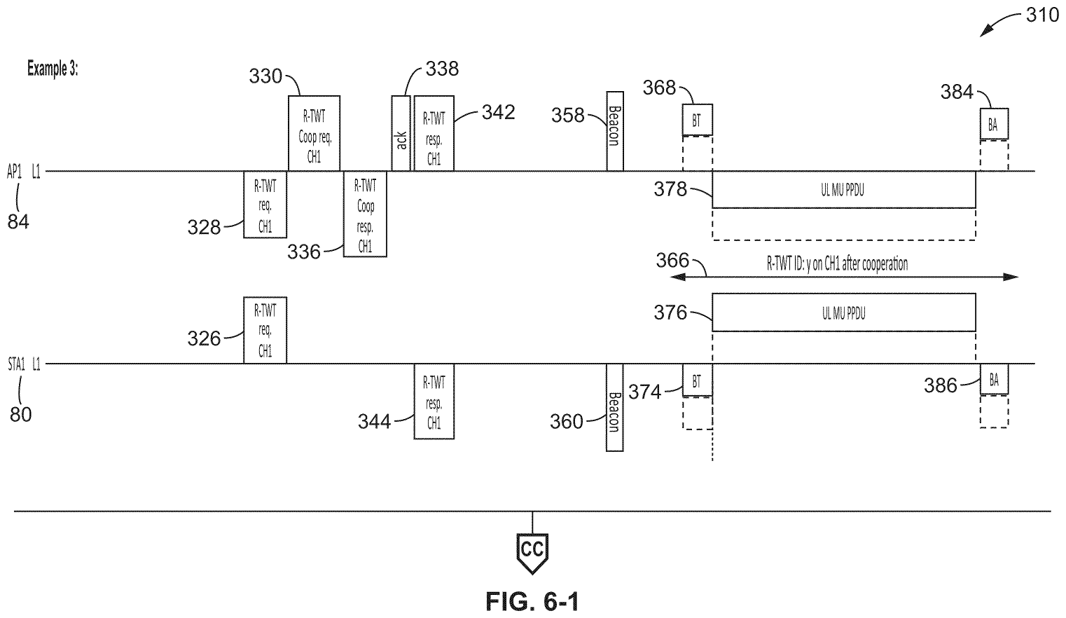

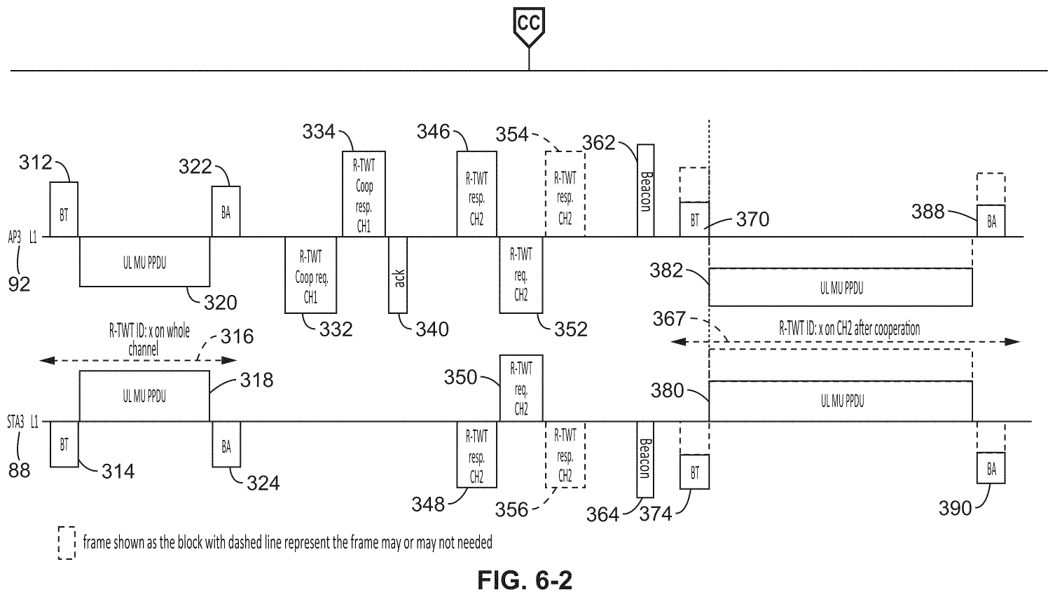

FIG. 6-1 and FIG. 6-2 illustrate communication diagram 310 as Example 3 depicting negotiating R-TWT membership on the channel level with a trigger-enabled R-TWT SP. The figure depicts interactions between AP1 84 on L1, STA1 80 on L1, AP3 92 on L1, and STA3 88 on L1. The initial negotiation process of R-TWT SP (ID: x) is not shown in figure.

STA3 is a R-TWT member STA of R-TWT SP (ID: x), which performs a trigger enabled R-TWT SP on link 1 (L1). AP3 sends Basic Trigger 312, which is received 314 by STA3 and thus STA3 commences R-TWT SP (ID x) 316 and transmits UL MU PPDU 318, received 320 by its associated AP3 which sends Block Ack (BA) frame 322, on the whole channel, and shown received by STA3.

STA1 transmits a R-TWT request frame 326, which is received 328 by its associated AP1 on link 1 (L1), with or without, indicating channel information (CH1) that it requested/suggested to operate on during the negotiated R-TWT SP (ID: y) if this R-TWT SP will be overlapped with any inter-BSS R-TWT SP.

In response to receiving the request, AP1 transmits a R-TWT cooperation request frame 330, which is received 332 by AP3 of the R-TWT cooperation response BSS on link 1 (L1). In the R-TWT cooperation request frame, the TWT element with R-TWT channel field indicates the current negotiation R-TWT information with the suggested/requested channel (CH1) of the corresponding R-TWT SP in the R-TWT cooperation request BSS. The suggested/requested channel (CH1) is decided based on the R-TWT requesting STA's suggestion/request or per the R-TWT scheduling AP's selection.

AP3, having received the R-TWT cooperation request frame from AP1 on link 1 (L1) checks the R-TWT negotiation information of the R-TWT cooperation request BSS and determines if the negotiated R-TWT SP (ID: y) will overlap with any scheduled/negotiated R-TWT SP(s), such as R-TWT SP (ID: x) from its own BSS. AP3 should respond a R-TWT cooperation response frame 334 to AP1 indicating its acceptance of allocating the requested channel CH1 to the R-TWT cooperation request BSS during the corresponding R-TWT SP (ID: y).

AP1 receives 336 the R-TWT cooperation response frame 334 from AP3, and AP1 is shown responding with an Ack frame 338 to indicate successful reception to AP3 which receives 340 the Ack. Then, AP1 sends an R-TWT response frame 342 to STA1 indicating the acceptance of allocation the channel (CH1) to STA1 during R-TWT SP (ID: y). STA1 receives 344 the response frame from AP1.

AP3 transmits an unsolicited R-TWT response frame 346 to the R-TWT member STAs of R-TWT SP (ID: x) which includes STA3. In the R-TWT response frame, AP3 should indicate the updated negotiation R-TWT information with the suggested/requested channel (CH2) of the corresponding R-TWT SP (ID: x).

After STA3 receives 348 the unsolicited R-TWT response frame 346 from AP3 and agrees with the updated channel allocation. STA3 is shown sending a new R-TWT request frame 350 with a suggested/requested updated channel (CH2) for the corresponding R-TWT SP (ID: x) to AP3. AP3 receives 352 the request frame 350, and optionally sends a R-TWT response frame 354 as a response indicating the acceptance of the suggested/requested updates of channel (CH2).

AP1 transmits Beacon frame 358 over link 1, and STA1 receives 360 Beacon frame 358 from AP1 over link 1. AP3 transmits Beacon frame 362 over link 1, and STA3 receives 364 Beacon frame 362 from AP3 over link 1.

The negotiated R-TWT SP (ID: y) between STA1 and AP1 is a trigger enabled R-TWT SP. When R-TWT SP (ID: y) 366 commences, AP1 sends BT frame 368 to STA1 using negotiated channel (CH1) to trigger UL MU PPDU 376. AP1 receives 378 the UL MU PPDU and responds with a Block Ack (BA) frame 384, which is received 386.

During the above time frame the figure depicts R-TWT SP (ID: x) 367 commencing, with AP3 sending BT frame 370 to STA3 using updated negotiated channel (CH2), and upon receipt 374, STA3 commences the UL MU PPDU 380, which is showing being received 382 by AP3. AP3 responds to proper receipt with a BA 388, and this is received 390 by STA3.

### 7. Flow Diagrams

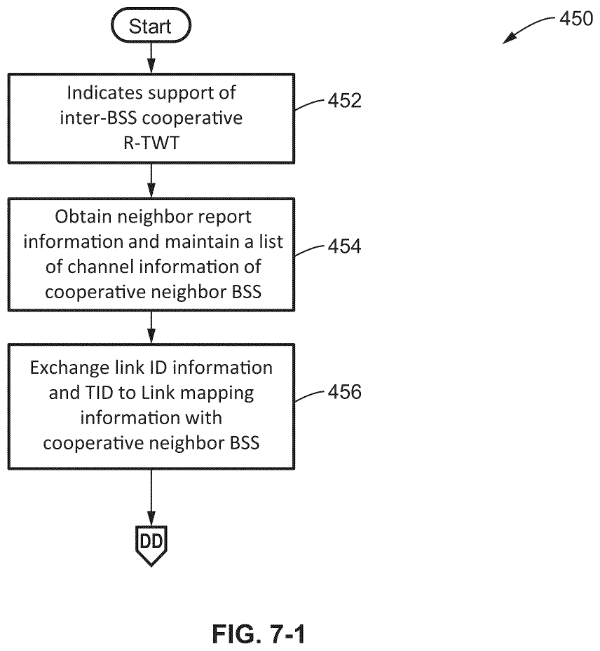

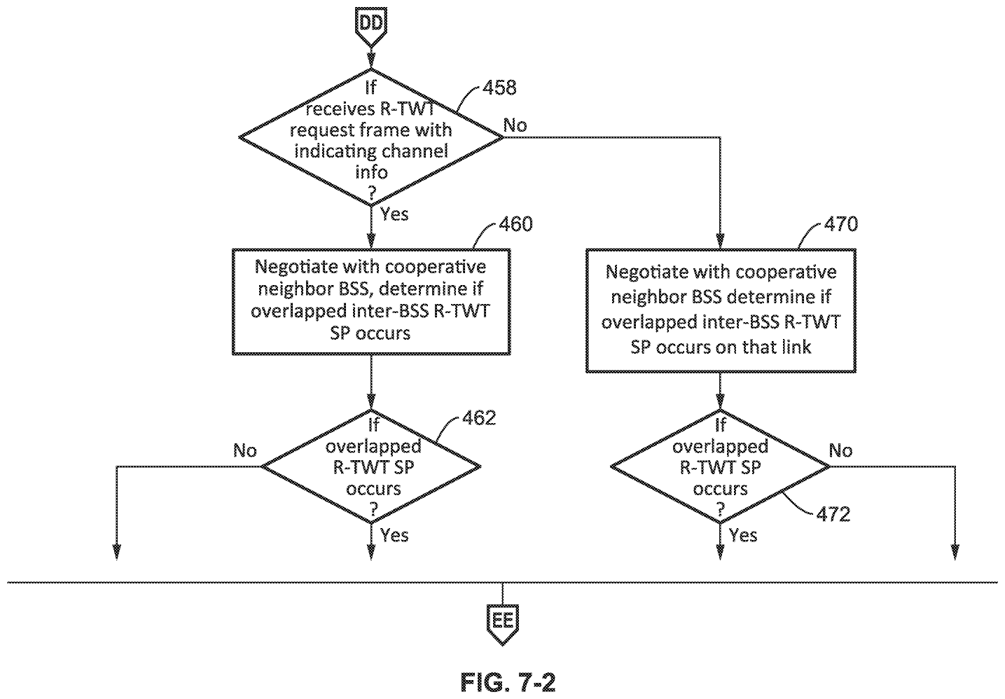

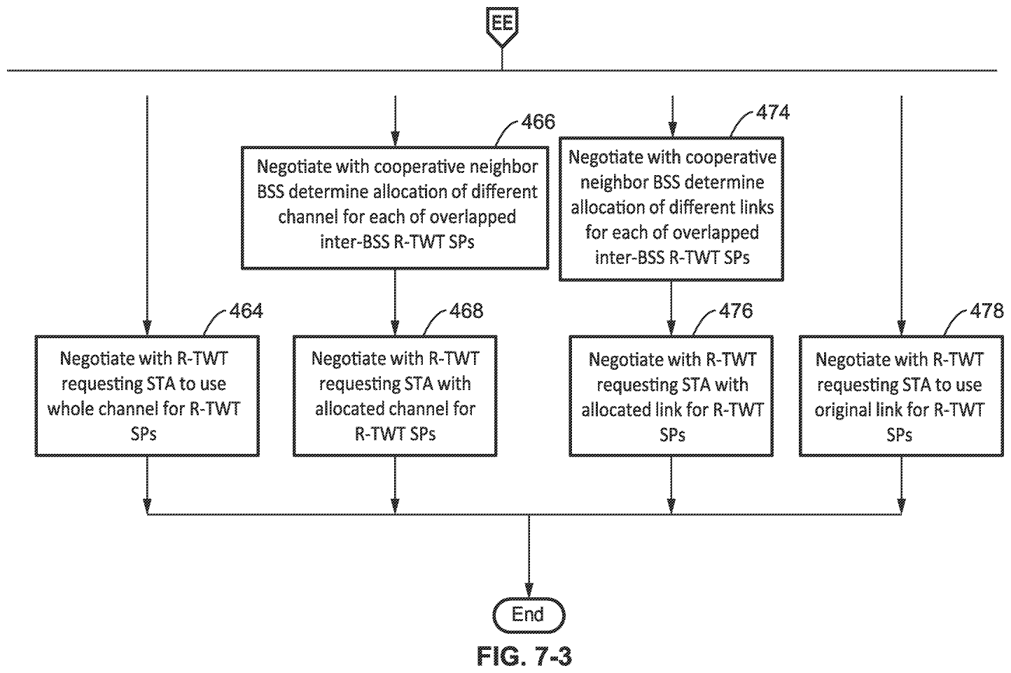

FIG. 7-1 through FIG. 7-3 illustrate an example embodiment 450 of R-TWT negotiations performed from the AP side. In FIG. 7-1 the AP indicates 452 support of inter-BSS cooperative R-TWT by setting up the cooperative R-TWT capability flag as introduced in Sec. 6. The AP then obtains 454 neighbor report information and maintains a list of channel information of the cooperative neighbor BSS. The AP then exchanges 456 link ID information and TID to Link mapping information with the cooperative neighbor BSS.

In FIG. 7-2 the AP then checks 458 if it has received an R-TWT request which indicates channel information. If the request was received, then at block 460 the AP negotiates with the cooperative neighbor BSS and determines if an overlapped inter-BSS R-TWT SP would occur. Check 462 then determines if the overlapped R-TWT SP has been indicated by the cooperative neighbor BSS. If there is no overlap, then execution moves to block 464 in FIG. 7-3 which negotiates with the R-TWT requesting STA to use the whole channel for R-TWT SPs, after which the process ends.

However, if there is an overlap detected at block 462 of FIG. 7-2, then block 466 of FIG. 7-3 is reached which negotiates with the cooperative neighbor BSS to determine allocation of a different channel for each of the overlapped inter-BSS T-TWT SPs. Then the AP negotiates 468 with the R-TWT requesting STA in regard to allocating a channel(s) for the R-TWT SPs, after which processing ends.

Returning to discuss check 458 in FIG. 7-2 in the case when the AP has not received an R-TWT request frame which indicates channel information, whereby block 470 is reached. Negotiation 470 is performed by the AP with a cooperative neighbor BSS to determine if an overlapped inter-BSS R-TWT SP would be present on that link. Check 472 then determines whether or not an overlap has been indicated by the cooperative neighbor BSS. If there is an indicated overlap, then at block 474 in FIG. 7-3 the AP negotiates with the cooperative neighbor BSS to determine allocation of different links for each of the overlapped inter-BSS R-TWT SPs. The AP then negotiates with the R-TWT requesting STA with allocated links for the R-TWT SPs, after which processing ends.

However, if it is determined at check 472 in FIG. 7-2 that there are no overlapping R-TWT SPs, then at block 478 in FIG. 7-3 the AP negotiates with the R-TWT requesting STA to use the original link for R-TWT SPs, and processing ends.

FIG. 8-1 through FIG. 8-2 illustrate an example embodiment 490 of R-TWT negotiations performed from the non-AP side. The non-AP STA transmits 492 an R-TWT request frame to its associated AP. A check 494 is made to determine if the non-AP STA has suggested or requested channel information.

If the non-AP STA has suggested or requested channel information, then at block 496 the non-AP STA receives an R-TWT response frame from the associated AP which indicates the allocated channel(s) for the R-TWT SPs. At check 498 it is determined if the allocated channel is different from the suggested or requested channel. If there is no change, then the process ends, otherwise at block 500 the non-AP STA transmits an R-TWT request frame to the associated AP indicating the different channel information, after which processing returns to block 496.

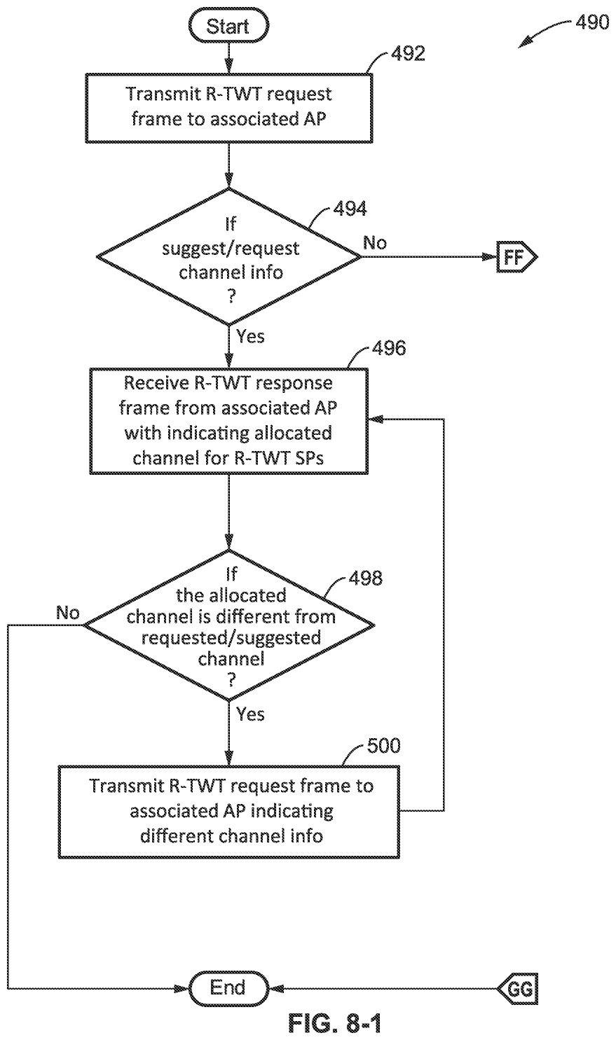

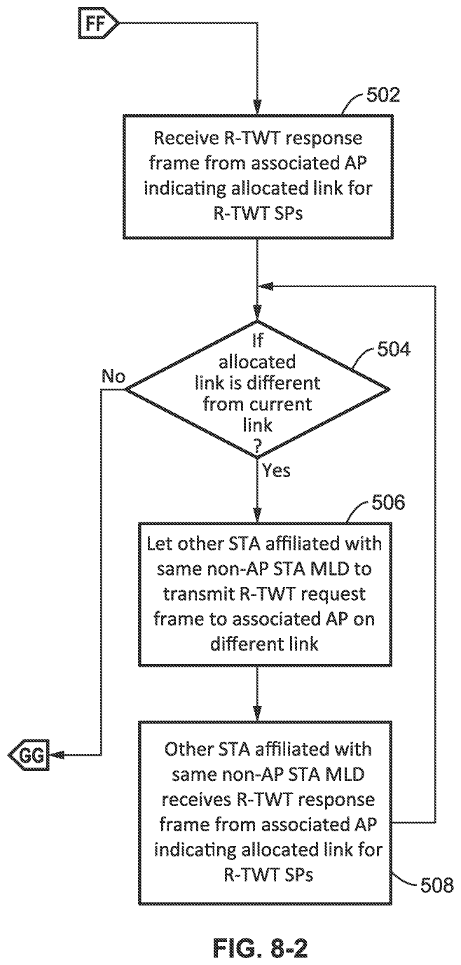

Returning now to consider block 494 when there is not information on a suggested or requested channel, whereby execution reaches block 502 in FIG. 8-2 which receives 502 the R-TWT response frame from the associated AP indicating an allocated link for R-TWT SPs. Check 504 determines if the allocated link is different from the current link. If there is no difference, then the process ends. Otherwise, at block 506 the non-AP STA allows the other STA affiliated with the same non-AP STA MLD to transmit an R-TWT request frame to the associated AP on a different link. Then at block 508 the other STA affiliated with the same non-AP STA MLD receives the R-TWT response frame from the associated AP indicating an allocated link for the R-TWT SPs, after which execution returns to check 504.

### 8. Frame Formats

### 8.1. LinkID-To-Channel-BSSID Mapping Element

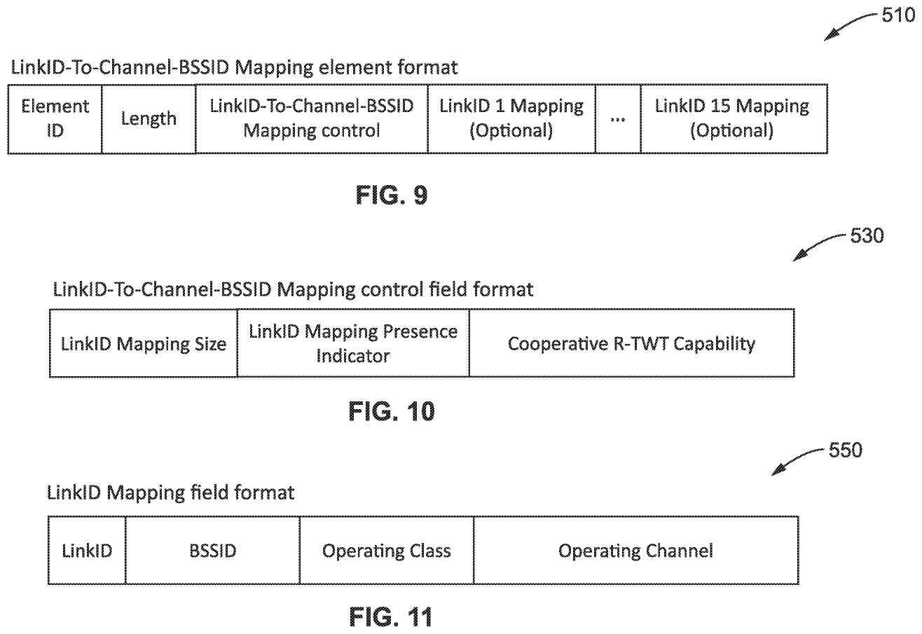

FIG. 9 illustrates an example embodiment 510 of a LinkID-To-Channel-BSSID mapping element format. The Element ID is used to identify the element, the Length field indicates the number of octets in the element excluding the Element ID and Length fields. A LinkID-To-Channel-BSSID Mapping Control field is designed per this disclosure to indicate the mapping of linkID to the tuple of operating class, operating channel and BSSID of the AP on that link. There are optional LinkID 1 Mapping through to LinkID n Mapping, depicted herein by way of example and not limitation with n being 15.

FIG. 10 illustrates an example embodiment 530 of the subfields within the LinkID-To-channel-BSSID mapping control field which was shown in FIG. 9. The LinkID Mapping Size subfield indicates the length of the LinkID Mapping n field. The LinkID Mapping Presence Indicator subfield indicates whether the LinkID n Mapping field is present in the LinkID-To-Channel-BSSID Mapping element. The Cooperative R-TWT Capability flag is set to a first state (e.g., ‘1’) to indicate the STA which transmitted this frame is supporting a cooperative R-TWT schedule with the R-TWT cooperation response BSS in the frequency domain when overlapped R-TWT SPs occur in the time domain; otherwise, the flag is set to a second state (e.g., ‘0’).

FIG. 11 illustrates an example embodiment 550 of the subfields within the LinkID n Mapping field, for which LinkID 1 Mapping field through LinkID 15 Mapping fields were depicted in FIG. 9. The LinkID n Mapping field indicates the mapping of LinkID n to the corresponding tuple of operating class, operating channel and BSSID of the AP on that link. The subfield LinkID indicates the link ID to be mapped. The BSSID subfield indicates the BSSID of the AP affiliated with the AP MLD operating on this link. The subfield Operating Class specifies the operating class in which the Operating Channel field is valid. The Operating Channel indicates the channel operating on this link, which may include channel starting frequency, channel spacing, channel set, channel center frequency index, while additional subfields may be included depending upon the application.

### 8.2. TWT Element for Channel/Link Level R-TWT Negotiation

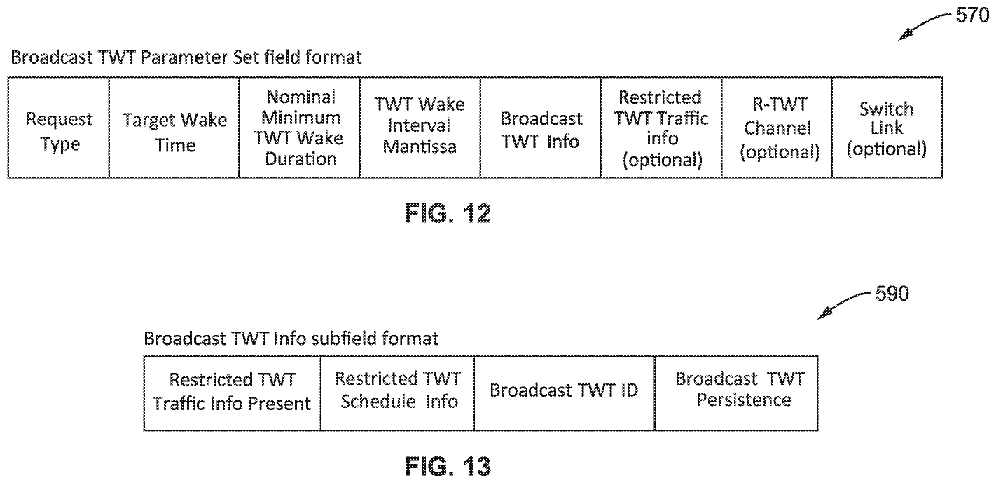

FIG. 12 illustrates an example embodiment 570 of a Broadcast TWT Parameter Set field format for use in a channel or link level cooperative R-TWT negotiation. Existing fields of Request Type, Target Wake Time, Nominal Minimum TWT Wake Duration, TWT Wake Interval Mantissa, and Broadcast TWT Information. The present disclosure adds the following fields to the current Broadcast TWT Parameter set field of TWT element.

A first of these added fields is the optional R-TWT Channel field, while the second is a Switch Link field.

The TWT Channel field is present if the transmitter STA supports the Cooperative R-TWT with setting the Cooperative R-TWT capability flag to true and leaving off (not present) the Switch Link field. If the transmitter STA does not support the Cooperative R-TWT, then the TWT Channel field is not present.

The TWT Channel field includes a bitmap that indicates the channel that is being negotiated by a STA as a temporary channel during a R-TWT SP, which overlaps with other R-TWT SP scheduled by OBSS in the time domain. Each bit in the bitmap corresponds to one minimum width channel (e.g., 20 MHz) for the band in which the TWT responding STA's associated BSS is currently operating, with the least significant bit corresponding to the lowest numbered channel of the operating channels of the BSS.

Setting a position in the bitmap of the TWT Channel field to a first state (e.g., ‘1’) transmitted by a TWT requesting STA indicates that operation with that channel as the temporary channel is requested during the corresponding R-TWT SP. Setting a position in the bitmap to this first state (e.g., ‘1’) transmitted by a TWT responding STA indicates that operation with that channel as the temporary channel is allowed during the corresponding R-TWT SP.

A R-TWT requesting STA from the R-TWT cooperation request BSS is allowed to suggest that its associated R-TWT scheduling AP assign the channel for the negotiated R-TWT SP by indicating R-TWT Channel information in the R-TWT request frame addressed to the associated AP.

The inter-BSS cooperative APs which support the inter-BSS Cooperative R-TWT exchange R-TWT cooperation request frames and R-TWT cooperation response frames which are carrying the TWT element that contains the negotiated R-TWT Channel information.

In addition to other R-TWT negotiation information, the R-TWT cooperation request AP transmits an R-TWT cooperation request frame to indicate the suggested channel for the R-TWT requesting STA from its BSS to the R-TWT cooperation response AP.

The R-TWT cooperation response AP from the OBSS, which receives the R-TWT cooperation request frame should be aware if there is any potential inter-BSS schedule of overlapped R-TWT SPs in the time domain. If it is determined that an overlapping inter-BSS SP will arise, then the R-TWT cooperation response AP should assist with scheduling a different channel for the overlapped inter-BSS R-TWT SPs. Accordingly, if the R-TWT cooperation response AP accepts the suggested or requested channel information received from the R-TWT cooperation request frame, it shall respond with an R-TWT cooperation response frame indicating that it accepts the channel to be allocated to the requesting BSS. If the R-TWT cooperation AP does not accept the suggested channel information, then it shall respond with an R-TWT cooperation response frame including an indication of its rejection of the suggested channel or it should indicate a different channel for the R-TWT cooperation request BSS during the corresponding R-TWT SP. If the overlapping inter-BSS SP will not occur, then the R-TWT cooperation response AP should in at least one embodiment inform the R-TWT cooperation request AP of this. Thus, the R-TWT cooperation response AP should respond with a R-TWT cooperation response frame carrying the TWT element with R-TWT channel field, which indicates the R-TWT cooperation request AP is to schedule a different channel as it suggested in the R-TWT cooperation request frame and to use the whole channel for the corresponding R-TWT SP.

The R-TWT cooperation response AP which sent the R-TWT cooperation response frame indicating the channel allocation for the overlapped inter-BSS R-TWT SP, shall schedule the R-TWT members of the corresponding R-TWT SP in its own BSS to preclude use of the channel as indicated in the R-TWT cooperation response frame. It may send an unsolicited R-TWT response frame or Beacon frames to the R-TWT member STAs of the corresponding R-TWT SP indicating the available channel information.

The R-TWT cooperation request AP receives the R-TWT cooperation response frame that indicates its suggested or requested channel is accepted by the R-TWT cooperation response BSS, it should schedule the R-TWT member STAs in its BSS to use the channel during the corresponding R-TWT SP by indicating corresponding information in the R-TWT response frame or Beacon frames. The R-TWT cooperation request AP receives the R-TWT cooperation response frame that indicates its suggested or requested channel is rejected, or a different channel is suggested or requested by the cooperative BSS, it shall reflect the corresponding information to the R-TWT member STAs in the R-TWT response frame or Beacon frames. If the R-TWT cooperation request AP receives the R-TWT cooperation response frame which indicates that the negotiated R-TWT SP does not overlap with other R-TWT SP from the R-TWT cooperation response BSS, then it should schedule the R-TWT member STAs in its BSS for using the entire (whole) channel during the corresponding R-TWT SP by indicating the corresponding information in the R-TWT response frame.

The Switch Link field is present if the transmitter STA supports the Cooperative R-TWT with setting the Cooperative R-TWT capability flag to true and the R-TWT Channel subfield not being used (present). If the transmitter STA does not support the Cooperative R-TWT, then the Switch Link field is not included in the Broadcast TWT Parameter Set field.

The Switch Link field indicates the link ID that is being negotiated by a STA as a temporary link to switch to during a R-TWT SP, which overlaps with other inter-BSS R-TWT SP in the time domain.

Setting of the Link ID in the Switch Link field, by a TWT requesting STA, indicates that operation with that link as the temporary link is requested during the corresponding R-TWT SP. Setting the Link ID in the Switch Link field, by a TWT responding STA. indicates that operation with that link as the temporary link is allowed during the corresponding R-TWT SP.

The R-TWT scheduling AP shall only suggest or request a temporary link to be switched to during a R-TWT SP if the suggested, or requested, link supports the TID(s) as negotiated on the original link based on the TID-to-Link mapping.

### 8.3. Restricted TWT Schedule Info Subfield

FIG. 13 illustrates an example embodiment 590 of subfields within the Broadcast TWT Information field that was shown in FIG. 12. A Restricted TWT Traffic Information present field is shown, and utilized conventionally. The Restricted TWT Schedule Information subfield for the present disclosure is increased in size by at least one additional bit (e.g., was originally two bits) with a new field value (e.g., ‘4’) indicating the advertised R-TWT schedule for which the R-TWT scheduling AP is likely to cooperate with another R-TWT scheduling AP from OBSS. There is also a Broadcast TWT ID field, and a Broadcast TWT Persistence field which can be utilized in the same manner as in previous 802.11be releases.

### 9. General Scope of Embodiments

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A station apparatus for communication in a wireless network, the apparatus comprising: (a) at least one modem coupled to at least one radio-frequency (RF) circuit, with each RF circuit connected to one or multiple antennas; (b) wherein said station (STA) operates in the wireless communications protocol as either an Access Point (AP) STA or a non-AP STA, for communicating with other STAs using a carrier sense multiple access/collision avoidance (CSMA/CA) mechanism, with said STA configured as a separate STA or as a STA within a multiple-link device (MLD); (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol, comprising: (e) (i) wherein said STA operates in the wireless communications protocol as either an Access Point (AP) STA or a non-AP STA, for communicating physical layer protocol data units (PPDUs) with other STAs using a carrier sense multiple access/collision avoidance (CSMA/CA) mechanism; (e) (ii) wherein said STA is an inter-basic service set (BSS) AP capable of performing inter-basic service set (BSS) communication with overlapping BSS (OBSS), and negotiation and participation in cooperative restricted-target wake time (R-TWT) service periods (SPs) that are overlapped in time and are scheduled on different links or different channels to avoid inter-BSS interference of prioritized traffic that has been scheduled to transmitted during the corresponding R-TWT SPs; and (e) (iii) wherein the inter-BSS AP, and other inter-BSS APs and STAs on other BSS indicate their support of an inter-BSS cooperative R-TWT by setting a flag which is transmitted to a cooperative BSS.

A station apparatus for communication in a wireless network, the apparatus comprising: (a) at least one modem coupled to at least one radio-frequency (RF) circuit, with each RF circuit connected to one or multiple antennas; (b) wherein said station (STA) operates in the wireless communications protocol as either an Access Point (AP) STA or a non-AP STA, for communicating with other STAs using a carrier sense multiple access/collision avoidance (CSMA/CA) mechanism, with said STA configured as a separate STA or as a STA within a multiple-link device (MLD); (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol, comprising: (e) (i) wherein said STA operates in the wireless communications protocol as either an Access Point (AP) STA or a non-AP STA, for communicating physical layer protocol data units (PPDUs) with other STAs using a carrier sense multiple access/collision avoidance (CSMA/CA) mechanism; (e) (ii) wherein said STA is an inter-basic service set (BSS) AP capable of performing inter-basic service set (BSS) communication with overlapping BSS (OBSS), and negotiation and participation in cooperative restricted-target wake time (R-TWT) service periods (SPs) that are overlapped in time and are scheduled on different links or different channels to avoid inter-BSS interference of prioritized traffic that has been scheduled to transmitted during the corresponding R-TWT SPs; (e) (iii) wherein inter-BSS APs exchange information from the cooperative BSS before performing the cooperative R-TWT negotiation; (e) (iv) wherein the inter-BSS AP obtains neighbor report information from one or more OBSS through measurement reports received from the STAs within each BSS, or obtains the information from a management interface, or information from the distribution system (DS); and (e) (v) wherein the inter-BSS AP, and other inter-BSS APs and STAs on other BSS indicate their support of an inter-BSS cooperative R-TWT by setting a flag which is transmitted to a cooperative BSS.

A method of performing communication in a wireless network, comprising: (a) each wireless station (STA) operates in the wireless communications protocol as either an Access Point (AP) STA or a non-AP STA, for communicating with other STAs using a carrier sense multiple access/collision avoidance (CSMA/CA) mechanism, with each said STA configured as a separate STA or as a STA within a multiple-link device (MLD); (b) wherein said STA operates in the wireless communications protocol as either an Access Point (AP) STA or a non-AP STA, for communicating physical layer protocol data units (PPDUs) with other STAs using a carrier sense multiple access/collision avoidance (CSMA/CA) mechanism; (c) wherein said STA is an inter-basic service set (BSS) AP capable of performing inter-basic service set (BSS) communication with overlapping BSS (OBSS), and negotiation and participation in cooperative restricted-target wake time (R-TWT) service periods (SPs) that are overlapped in time and are scheduled on different links or different channels to avoid inter-BSS interference of prioritized traffic that has been scheduled to transmitted during the corresponding R-TWT SPs; and (d) wherein the inter-BSS AP, and other inter-BSS APs and STAs on other BSS indicate their support of an inter-BSS cooperative R-TWT by setting a flag which is transmitted to a cooperative BSS.

An apparatus or method in which inter-BSS devices are capable of support, negotiate and participate in the cooperative R-TWT SPs that are overlapped in time and are scheduled on different links or different channels to avoid the inter-BSS interference of the prioritized traffic that has been scheduled to transmitted during the corresponding R-TWT SPs.

An apparatus or method in which inter-BSS devices may indicate its support of the inter-BSS cooperative R-TWT by setting up a flag that could be transmitted to the cooperative BSS.

An apparatus or method in which inter-BSS APs should be aware of some BSS information from the cooperative BSS before the cooperative R-TWT negotiation.

An apparatus or method in which inter-BSS APs may cooperate with each other to negotiate R-TWT membership on channel level.

An apparatus or method in which an AP can obtain neighbor report information of OBSS(s) through measurement reports received from the STAs within the BSS, or obtain the information through a management interface, or information from the DSI wherein the neighbor report contains information comprising: BSSID, the primary channel, TSF Offset, Beacon interval, and other optional information of the reported neighbor BSS.

An apparatus or method in which an AP maintains a list of channels information that corresponds to its neighbor APs; wherein the channel information can be obtained from the AP's neighbor report; wherein the list of channels information is contained in the AP Channel Report element carried in the Beacon frame.

An apparatus or method in which an AP exchanges link ID information with the cooperative AP and indicates the link ID corresponding to the tuple consisting of operating class, operating channel and BSSID of the AP on that link.

The apparatus or method of any preceding implementation, wherein the AP exchanges TID-to-Link mapping information with the cooperative AP.

The apparatus or method of any preceding implementation, wherein inter-BSS APs exchange information from the cooperative BSS before performing the cooperative R-TWT negotiation.

The apparatus or method of any preceding implementation, wherein the inter-BSS AP obtains neighbor report information from one or more OBSS through measurement reports received from the STAs within each BSS, or obtains the information from a management interface, or information from the distribution system (DS).

The apparatus or method of any preceding implementation, wherein the neighbor report comprises information on BSSID, primary channel, timing synchronization function (TSF) offset, and beacon interval, for the reported neighbor BSS.

The apparatus or method of any preceding implementation, wherein the inter-BSS AP maintains a list of channel information about neighboring APs; and wherein the channel information is obtained from a report from a neighboring AP, or a list of channels and associated information is contained in an AP channel report element carried in a beacon frame.

The apparatus or method of any preceding implementation, wherein the inter-BSS AP exchanges link ID information with the cooperative AP of another BSS by indicating the link ID corresponding to the tuple consisting of operating class, operating channel and BSSID of the AP on that link.

The apparatus or method of any preceding implementation, wherein the inter-BSS AP exchanges TID-to-Link mapping information with the cooperative AP.

The apparatus or method of any preceding implementation, wherein the inter-BSS AP cooperates with inter-BSS APs of other BSS to negotiate R-TWT membership on a channel level.

The apparatus or method of any preceding implementation, wherein to negotiate with inter-BSS APs of other BSS a TWT channel subfield is added in a broadcast TWT parameter set field; wherein the TWT channel subfield is present if the transmitter STA supports the cooperative R-TWT and a switch Link field is not present; otherwise, the TWT channel field is not present.

The apparatus or method of any preceding implementation, wherein the inter-BSS AP performing R-TWT scheduling and an R-TWT requesting STA perform negotiations for an R-TWT SP to operate on a specific channel as indicated in the TWT channel field through exchanging of a R-TWT request frame and a R-TWT response frame.

The apparatus or method of any preceding implementation, wherein the STA, operating as an inter-BSS AP which transmitted either the R-TWT request frame or the R-TWT response frame, negotiates with an inter-BSS AP from a cooperative BSS to determine if the R-TWT SPs are overlapped in the time domain, in which case different channels are allocated for each of the overlapped inter-BSS R-TWT SPs.

The apparatus or method of any preceding implementation, wherein the STA, operating as an inter-BSS AP which transmitted either the R-TWT request frame or the R-TWT response frame, negotiates with an inter-BSS AP from a cooperative BSS to determine if the R-TWT SPs are overlapped in the time domain; wherein if there is no overlap then the inter-BSS AP sending the R-TWT request frame requests to allocate a whole channel to the R-TWT member STAs of the corresponding negotiated R-TWT SP.

The apparatus or method of any preceding implementation, wherein the STA operating as inter-BSS AP cooperates with inter-BSS APs of other BSSs to negotiate R-TWT membership on a link level which does not violate the TID-to-link mapping.

The apparatus or method of any preceding implementation, wherein a subfield in the broadcast TWT parameter set field of a TWT information element contains information about a switch link field which is present if the transmitting STA supports the cooperative R-TWT and an R-TWT channel subfield is not present.

The apparatus or method of any preceding implementation, wherein the STA when operating as an R-TWT requesting STA sends to an AP, operating as an associated R-TWT scheduling AP, an R-TWT request frame on a link in which there is no R-TWT channel subfield presented in the TWT element indicating it can negotiate with the R-TWT SP to utilize the duration of the whole link.

The apparatus or method of any preceding implementation, wherein the STA operating as an R-TWT cooperation request AP negotiates with another STA, in a cooperative BSS, operating as the R-TWT cooperation response AP; wherein negotiations determine if the R-TWT SPs are overlapped in the time domain on the same link, wherein different links are allocated for each of the overlapped inter-BSS R-TWT SPs.

The apparatus or method of any preceding implementation, wherein the STA operating as an R-TWT cooperation request AP negotiates with another STA operating as the R-TWT cooperation response AP from a cooperative BSS, to determine if the R-TWT SPs are not overlapped in the time domain on the same link, whereby if there is no overlap, the R-TWT cooperation request AP allocates an entire link to the R-TWT member STAs of the corresponding negotiated R-TWT SP.

The apparatus or method of any preceding implementation, wherein the STA operating as the R-TWT scheduling AP sends a suggested, or requested, link for the R-TWT requesting STA to use if an overlapped inter-BSS R-TWT SP is predicted on the original link.

The apparatus or method of any preceding implementation, wherein the STA operating as the R-TWT scheduling AP sends an indication to the R-TWT requesting STA indicated that it is to use the original link if an overlapped inter-BSS R-TWT SP is not predicted on the original link.

The apparatus or method of any preceding implementation, wherein the STA operating as the R-TWT requesting STA inform another STA which is affiliated with its same non-AP MLD, to negotiate the R-TWT SP on a different link, as suggested or requested as indicating in the received R-TWT response frame.

The apparatus or method of any preceding implementation, wherein the STA operating as the R-TWT scheduling AP suggests or requests use of a different link to switch to during a R-TWT SP if the suggested or requested link supports the TID(s) as negotiated on the original link based on the TID-to-Link mapping.

The apparatus or method of any preceding implementation, wherein a restricted TWT schedule Information subfield of the broadcast TWT Information subfield in the TWT element is configured for indicating advertised scheduling.

The apparatus or method of any preceding implementation, wherein the broadcast TWT Information subfield in the TWT element is set to a unique value indicating an advertised R-TWT schedule for which the STA operating at the R-TWT scheduling AP is expected to cooperate with another R-TWT scheduling AP from the OBSS.

The apparatus or method of any preceding implementation, wherein the inter-BSS APs may cooperate with each other to negotiate R-TWT membership on channel level.

The apparatus or method of any preceding implementation, wherein the inter-BSS APs may cooperate with each other to negotiate R-TWT membership on link level, which shall not violate the TID-to-link mapping.

The apparatus or method of any preceding implementation, wherein one subfield is added in current Broadcast TWT Parameter set field of the TWT element which is the TWT Channel field; and wherein the TWT Channel field is present if the transmitter STA support the Cooperative R-TWT and the Switch Link field is not present; otherwise, the TWT Channel field shall not be present.

The apparatus or method of any preceding implementation, wherein the R-TWT scheduling AP and R-TWT requesting STA negotiate the R-TWT SP to operate on a specific channel as indicated in the TWT Channel field through exchange of R-TWT request frame and R-TWT response frame.

The apparatus or method of any preceding implementation, wherein the R-TWT cooperation request AP and the R-TWT cooperation response AP from the cooperative BSSs negotiate to determine if the R-TWT SPs is overlapped in time domain and to allocate different channel for each of the overlapped inter-BSS R-TWT SPs.

The apparatus or method of any preceding implementation, wherein the R-TWT cooperation request AP and the R-TWT cooperation response AP from the cooperative BSSs negotiate to determine if the R-TWT SPs is not overlapped in time domain and to inform the R-TWT cooperation request AP to allocate a whole channel to the R-TWT member STAs of the corresponding negotiated R-TWT SP.

The apparatus or method of any preceding implementation, further comprising adding one subfield in the current Broadcast TWT Parameter set filed of TWT element which is the TWT Channel field. The TWT Channel field is present if the transmitter STA support the Cooperative R-TWT and the Switch Link field is not present. Otherwise, the TWT Channel field shall not present.

The apparatus or method of any preceding implementation, wherein the R-TWT scheduling AP and R-TWT requesting STA negotiate the R-TWT SP to operate on a specific channel as indicated in the TWT Channel field through exchange of R-TWT request frame and R-TWT response frame.

The apparatus or method of any preceding implementation, wherein the R-TWT cooperation request AP and the R-TWT cooperation response AP from the cooperative BSSs should negotiate to determine if the R-TWT SPs is overlapped in time domain and to allocate different channel for each of the overlapped inter-BSS R-TWT SPs.

The apparatus or method of any preceding implementation, wherein the R-TWT cooperation request AP and the R-TWT cooperation response AP from the cooperative BSSs should negotiate to determine if the R-TWT SPs is not overlapped in time domain and to inform the R-TWT cooperation request AP to allocate whole channel to the R-TWT member STAs of the corresponding negotiated R-TWT SP.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A station apparatus for communication in a wireless network, the apparatus comprising:
(a) at least one modem coupled to at least one radio-frequency (RF) circuit, with each RF circuit connected to one or multiple antennas;
(b) wherein said station (STA) operates in the wireless communications protocol as either an Access Point (AP) STA or a non-AP STA, for communicating with other STAs using a carrier sense multiple access/collision avoidance (CSMA/CA) mechanism, with said STA configured as a separate STA or as a STA within a multiple-link device (MLD);
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol, comprising:
(i) wherein said STA operates in the wireless communications protocol as either an Access Point (AP) STA or a non-AP STA, for communicating physical layer protocol data units (PPDUs) with other STAs using a carrier sense multiple access/collision avoidance (CSMA/CA) mechanism;
(ii) wherein said STA is an inter-basic service set (BSS) AP capable of performing inter-basic service set (BSS) communication with overlapping BSS (OBSS), and negotiation and participation in cooperative restricted-target wake time (R-TWT) service periods (SPs) that are overlapped in time and are scheduled on different links or different channels to avoid inter-BSS interference of prioritized traffic that has been scheduled to transmitted during the corresponding R-TWT SPs; and
(iii) wherein the inter-BSS AP, and other inter-BSS APs and STAs on other BSS indicate their support of an inter-BSS cooperative R-TWT by setting a flag which is transmitted to a cooperative BSS.

2. The apparatus of claim 1, wherein inter-BSS APs exchange information from the cooperative BSS before performing the cooperative R-TWT negotiation.

3. The apparatus of claim 1, wherein the inter-BSS AP obtains neighbor report information from one or more OBSS through measurement reports received from the STAs within each BSS, or obtains the information from a management interface, or information from the distribution system (DS).

4. The apparatus of claim 3, wherein the neighbor report comprises information on BSSID, primary channel, timing synchronization function (TSF) offset, and beacon interval, for the reported neighbor BSS.

5. The apparatus of claim 3, wherein the inter-BSS AP maintains a list of channel information about neighboring APs; and wherein the channel information is obtained from a report from a neighboring AP, or a list of channels and associated information is contained in an AP channel report element carried in a beacon frame.

6. The apparatus of claim 3, wherein the inter-BSS AP exchanges link ID information with the cooperative AP of another BSS by indicating the link ID corresponding to the tuple consisting of operating class, operating channel and BSSID of the AP on that link.

7. The apparatus of claim 3, wherein the inter-BSS AP exchanges TID-to-Link mapping information with the cooperative AP.

8. The apparatus of claim 1, wherein the inter-BSS AP cooperates with inter-BSS APs of other BSS to negotiate R-TWT membership on a channel level.

9. The apparatus of claim 8, wherein to negotiate with inter-BSS APs of other BSS a TWT channel subfield is added in a broadcast TWT parameter set field; wherein the TWT channel subfield is present if the transmitter STA supports the cooperative R-TWT and a switch Link field is not present; otherwise, the TWT channel field is not present.

10. The apparatus of claim 8, wherein the inter-BSS AP performing R-TWT scheduling and an R-TWT requesting STA perform negotiations for an R-TWT SP to operate on a specific channel as indicated in the TWT channel field through exchanging of a R-TWT request frame and a R-TWT response frame.

11. The apparatus of claim 10, wherein the STA, operating as an inter-BSS AP which transmitted either the R-TWT request frame or the R-TWT response frame, negotiates with an inter-BSS AP from a cooperative BSS to determine if the R-TWT SPs are overlapped in the time domain, in which case different channels are allocated for each of the overlapped inter-BSS R-TWT SPs.

12. The apparatus of claim 10, wherein the STA, operating as an inter-BSS AP which transmitted either the R-TWT request frame or the R-TWT response frame, negotiates with an inter-BSS AP from a cooperative BSS to determine if the R-TWT SPs are overlapped in the time domain; wherein if there is no overlap then the inter-BSS AP sending the R-TWT request frame requests to allocate a whole channel to the R-TWT member STAs of the corresponding negotiated R-TWT SP.

13. The apparatus of claim 1, wherein the STA operating as inter-BSS AP cooperates with inter-BSS APs of other BSSs to negotiate R-TWT membership on a link level which does not violate the TID-to-link mapping.

14. The apparatus of claim 13, wherein a subfield in the broadcast TWT parameter set field of a TWT information element contains information about a switch link field which is present if the transmitting STA supports the cooperative R-TWT and an R-TWT channel subfield is not present.

15. The apparatus of claim 13, wherein the STA when operating as an R-TWT requesting STA sends to an AP, operating as an associated R-TWT scheduling AP, an R-TWT request frame on a link in which there is no R-TWT channel subfield presented in the TWT element indicating it can negotiate with the R-TWT SP to utilize the duration of the whole link.

16. The apparatus of claim 13, wherein the STA operating as an R-TWT cooperation request AP negotiates with another STA, in a cooperative BSS, operating as the R-TWT cooperation response AP; wherein negotiations determine if the R-TWT SPs are overlapped in the time domain on the same link, wherein different links are allocated for each of the overlapped inter-BSS R-TWT SPs.

17. The apparatus of claim 13, wherein the STA operating as an R-TWT cooperation request AP negotiates with another STA operating as the R-TWT cooperation response AP from a cooperative BSS, to determine if the R-TWT SPs are not overlapped in the time domain on the same link, whereby if there is no overlap, the R-TWT cooperation request AP allocates an entire link to the R-TWT member STAs of the corresponding negotiated R-TWT SP.

18. The apparatus of claim 13, wherein the STA operating as the R-TWT scheduling AP sends a suggested, or requested, link for the R-TWT requesting STA to use if an overlapped inter-BSS R-TWT SP is predicted on the original link.

19. The apparatus of claim 18, wherein the STA operating as the R-TWT scheduling AP sends an indication to the R-TWT requesting STA indicated that it is to use the original link if an overlapped inter-BSS R-TWT SP is not predicted on the original link.

20. The apparatus of claim 13, wherein the STA operating as the R-TWT requesting STA inform another STA which is affiliated with its same non-AP MLD, to negotiate the R-TWT SP on a different link, as suggested or requested as indicating in the received R-TWT response frame.

21. The apparatus of claim 13, wherein the STA operating as the R-TWT scheduling AP suggests or requests use of a different link to switch to during a R-TWT SP if the suggested or requested link supports the TID(s) as negotiated on the original link based on the TID-to-Link mapping.

22. The apparatus of claim 1, wherein a restricted TWT schedule Information subfield of the broadcast TWT Information subfield in the TWT element is configured for indicating advertised scheduling.

23. The apparatus of claim 22, wherein the broadcast TWT Information subfield in the TWT element is set to a unique value indicating an advertised R-TWT schedule for which the STA operating at the R-TWT scheduling AP is expected to cooperate with another R-TWT scheduling AP from the OBSS.

24. A station apparatus for communication in a wireless network, the apparatus comprising:
(a) at least one modem coupled to at least one radio-frequency (RF) circuit, with each RF circuit connected to one or multiple antennas;
(b) wherein said station (STA) operates in the wireless communications protocol as either an Access Point (AP) STA or a non-AP STA, for communicating with other STAs using a carrier sense multiple access/collision avoidance (CSMA/CA) mechanism, with said STA configured as a separate STA or as a STA within a multiple-link device (MLD);
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol, comprising:
(i) wherein said STA operates in the wireless communications protocol as either an Access Point (AP) STA or a non-AP STA, for communicating physical layer protocol data units (PPDUs) with other STAs using a carrier sense multiple access/collision avoidance (CSMA/CA) mechanism;
(ii) wherein said STA is an inter-basic service set (BSS) AP capable of performing inter-basic service set (BSS) communication with overlapping BSS (OBSS), and negotiation and participation in cooperative restricted-target wake time (R-TWT) service periods (SPs) that are overlapped in time and are scheduled on different links or different channels to avoid inter-BSS interference of prioritized traffic that has been scheduled to transmitted during the corresponding R-TWT SPs;
(iii) wherein inter-BSS APs exchange information from the cooperative BSS before performing the cooperative R-TWT negotiation;
(iv) wherein the inter-BSS AP obtains neighbor report information from one or more OBSS through measurement reports received from the STAs within each BSS, or obtains the information from a management interface, or information from the distribution system (DS); and
(v) wherein the inter-BSS AP, and other inter-BSS APs and STAs on other BSS indicate their support of an inter-BSS cooperative R-TWT by setting a flag which is transmitted to a cooperative BSS.

25. A method of performing communication in a wireless network, comprising:
(a) each wireless station (STA) operates in the wireless communications protocol as either an Access Point (AP) STA or a non-AP STA, for communicating with other STAs using a carrier sense multiple access/collision avoidance (CSMA/CA) mechanism, with each said STA configured as a separate STA or as a STA within a multiple-link device (MLD);
(b) wherein said STA operates in the wireless communications protocol as either an Access Point (AP) STA or a non-AP STA, for communicating physical layer protocol data units (PPDUs) with other STAs using a carrier sense multiple access/collision avoidance (CSMA/CA) mechanism;
(c) wherein said STA is an inter-basic service set (BSS) AP capable of performing inter-basic service set (BSS) communication with overlapping BSS (OBSS), and negotiation and participation in cooperative restricted-target wake time (R-TWT) service periods (SPs) that are overlapped in time and are scheduled on different links or different channels to avoid inter-BSS interference of prioritized traffic that has been scheduled to transmitted during the corresponding R-TWT SPs; and
(d) wherein the inter-BSS AP, and other inter-BSS APs and STAs on other BSS indicate their support of an inter-BSS cooperative R-TWT by setting a flag which is transmitted to a cooperative BSS.
